(19) United States
(12) Patent Application Publication
(10) Pub. No.: US 2026/0060881 A1
(43) Pub. Date: Mar. 5, 2026

(54) THERMAL EYELID MASSAGE

(71) Applicant: Wisconsin Alumni Research Foundation, Madison, WI (US)

(72) Inventor: Ryan Larochelle, Madison, WI (US)

(21) Appl. No.: 18/819,345

(22) Filed: Aug. 29, 2024

(51) Int. Cl. A61H 15/02; A61H 15/00

(52) U.S. Cl. CPC A61H 15/02; A61H 15/0078; A61H 2015/0021; A61H 2201/0157; A61H 2201/0207; A61H 2201/10; A61H 2201/1215; A61H 2201/1607; A61H 2201/165; A61H 2201/50; A61H 2205/024

(57) ABSTRACT

Aspects of the disclosure are directed to apparatuses and methods for heating eyelids, with specific aspects directed toward heating and massaging fluid from glands in the eyelids. As may be implemented in accordance with one or more embodiments as characterized herein, an apparatus includes a frame and at least one roller coupled to the frame, and an actuator to rotate the at least one roller. Each roller has an integrated heating element to heat the roller. With the frame positioning the roller against a surface over one of the eyelids, the actuator, frame and roller operate to apply both pressure and heat to the surface and to the one of the eyelids via the at least one roller. This heat and pressure is applied while rotating the at least one roller to massage the surface and the one of the eyelids in a direction of the rotation.

### BACKGROUND

For many applications, it is desirable to massage tissue to achieve a variety of results. One such application involves treating meibomian gland dysfunction (MGD), a disease in which meibum, a lipid formed in the meibomian glands, becomes thickened and cannot be properly secreted onto the ocular surface. The eyelids contain a firm plate of tissue called the tarsus.

Within the tarsus resides meibomian glands, the lipid within which empties onto the ocular surface through small pores near the base of the eyelashes. This lipid contributes to the balance of tear film and has important implications for patients with dry eye syndrome. When the glands are clogged, patients develop irritation and styes. Eye care providers recommend warm compresses to liquefy the contents of the glands (i.e. melt the buttery, clogged content into a less viscous olive oil consistency), then a gentle massage to express the fluid from the glands.

Certain treatment techniques are limited in application, may be expensive, may be limited in application to either heat or massage, or may deliver massage in a non-targeted way without respect to the orientation of the meibomian glands. Other treatment techniques involve a warm compress worn over the eyes, and delivering manual massage to express the glands, however manual massage is often challenging to perform properly.

These and other matters have presented challenges to eyelid massage for a variety of applications.

### SUMMARY

Various example embodiments are directed to heating and messaging eyelids, related apparatuses, their application and their manufacture. Such embodiments may be useful for treating conditions such as those specified in connection with the issues noted above, for example to express meibomian glands.

As may be implemented in accordance with one or more embodiments, an apparatus for heating eyelids includes a frame, at least one roller coupled to the frame, and an actuator to rotate the at least one roller. Each roller has an integrated heating element to heat the roller. The actuator is configured with the frame and the at least one roller to, with the frame positioning the roller against one of the eyelids, apply pressure and heat to the one of the eyelids via the at least one roller, while rotating the at least one roller to massage the one of the eyelids in a direction of the rotation.

Another embodiment is directed to an apparatus comprising a frame, a plurality of rollers coupled to the frame, and an actuator. Each roller has an integrated heating element to heat the roller, and a gap region extending along a length of the roller. The actuator is configured with the frame and the rollers to, with the frame positioning each roller against a surface, apply pressure and heat to the surface via the rollers while rotating the rollers, including utilizing the gap region to relieve pressure applied by the roller when the gap is engaged with the surface, therein massaging the surface in a direction of the rotation.

A further embodiment is directed to a method for heating eyelids. The method includes providing a frame and at least one roller coupled to the frame, each roller having an integrated heating element to heat the roller. Using an actuator, with the frame positioning the at least one roller against one of the eyelids, pressure and heat are applied to the one of the eyelids via the at least one roller, by rotating the at least one roller to massage the one of the eyelids in a direction of the rotation.

The above discussion/summary is not intended to describe each embodiment or every implementation of the present disclosure. The figures and detailed description that follow exemplify various embodiments.

### BRIEF DESCRIPTION OF FIGURES

Various example embodiments may be more completely understood in consideration of the following detailed description and in connection with the accompanying drawings, in which:

FIGS. 1A-1E show a roller apparatus with incorporated heating, in accordance with one or more embodiments, in which:

FIG. 1A shows an isometric view of the roller apparatus;

FIG. 1B shows a rear view of the roller apparatus;

FIG. 1C shows a front view of the roller apparatus;

FIG. 1D shows an end view of the roller apparatus; and

FIG. 1E shows a cut-away view of an implementation utilizing a heating coil at a core portion of the roller apparatus;

FIGS. 2A and 2B show an elongated roller apparatus with incorporated heating, in accordance with various embodiments, and in which:

FIG. 2A shows a perspective view of the roller apparatus; and

FIG. 2B shows a front view of the roller apparatus;

FIG. 3 shows an apparatus for applying pressure and heat to upper and lower eyelids, as may be implemented in accordance with one or more embodiments; and

FIG. 4 shows a goggle apparatus having rollers with incorporated heating, as may be implemented in accordance with one or more embodiments.

While various embodiments discussed herein are amenable to modifications and alternative forms, aspects thereof have been shown by way of example in the drawings and will be described in detail. It should be understood, however, that the intention is not to limit the invention to the particular embodiments described. On the contrary, the intention is to cover all modifications, equivalents, and alternatives falling within the scope of the disclosure including aspects defined in the claims. In addition, the term “example” as may be used throughout this application is by way of illustration, and not limitation.

### DETAILED DESCRIPTION

Aspects of the present disclosure are believed to be applicable to a variety of different types of articles of manufacture, apparatuses, systems and methods involving the application of heat and message. In certain implementations, aspects of the present disclosure may be beneficial when used in the context of messaging areas near the human eye, such as to message meibomian glands. Other implementations may involve other areas of medicine, such as for thermal scar massage. As such, various aspects of the disclosure are directed to addressing issues noted above, such as those relating to patient compliance and competence, and to expensive clinical treatments. While not necessarily so limited, various aspects may be appreciated through a discussion of examples using such exemplary contexts.

In a particular embodiment, an apparatus includes one or more bean-shaped rollers, each having an integrated heating element for treatment of meibomian gland dysfunction (MGD). Each roller may rotate towards the eyelash line to massage the glands. The rollers may include a gap or other region that exhibits a reduced or eliminated application of force such that the rotation of the rollers may be implemented to apply directional compressive force to the glands with a period of non-contact to allow the skin to retract. It has been recognized and/or discovered that the application of intermittent pressure, allowing the eyelids to return to a relaxed state in between rotations, produces desirable expression of the glands. This may replicate a linear manual massage, and ensure a directional application of force to the glands for releasing meibum.

Accordingly, various aspects are directed to treating vertically oriented meibomian glands in the eyelids, which secrete oils near the base of the eyelashes that contribute to a balanced tear film. Specific aspects involve a reusable device that can deliver heat as well as targeted massage therapy to express the meibomian glands, addressing MGD symptoms such as irritation and styes due to clogged meibomian glands. Thermally conductive silicone may be utilized for the rollers to allow for even heat distribution, and a PLA filament may be utilized to provide heat, with insulating properties.

The heat and force may be set such that they are sufficient to adequately heat and compress the glands, effectively treating MGD. For instance, the surface temperature of the device may be set to reach about 43° C. A compressive force (e.g., 6N, or not exceed 109 mmHg) normal to the eyelid across the geometry of the bean roller may be applied to the eyelid to sufficiently compress the glands to express the meibum. Mechanical movement is incorporated to apply force to the eyelid, and a heating element such as a nickel-chromium (nichrome) alloy may be utilized to provide heat. Two rollers may be utilized per eye, and applied to exert directed force onto the eyelids to compress the meibomian glands. In particular implementations, heat and pressure are simultaneously applied above and below both eyelids. In certain implementations, a wearable device may include a goggle-type frame and four of the aforementioned bean-shaped rollers to cover both the upper and lower eyelids for each eye. Approaches involving such an implementation may be utilized for two, five-minute daily uses, which may effectively relieve symptoms of MGD.

In accordance with a particular embodiment, an apparatus for heating eyelids includes a frame, at least one roller coupled to the frame, and an actuator to rotate the at least one roller. Each roller has an integrated heating element to heat the roller. With the frame positioning the roller against one of the eyelids, the actuator, frame and roller operate to apply pressure and heat to the eyelid via the roller, while rotating the roller to massage the eyelid in a direction of the rotation. Each roller may be attached to a shaft, and for each roller, the actuator may be coupled to the shaft and to the frame to rotate the shaft and roller coupled thereto.

Multiple rollers may be utilized to massage one, two, three or four eyelids, to suit particular applications. In a particular implementation, four rollers are coupled to the frame, and the frame is wearable by a patient. The frame aligns each of the four rollers respectively to four eyelids of the patient, and the rollers are rotated while applying heat and pressure to the eyelids to heat fluid in the patient's meibomian glands and to push the heated fluid out of the glands.

The frame in the above examples may be coupled to goggles that can be worn on the patient's head. A strap may operate with the goggles and frame to position the rollers against the patient's eyelids.

The rollers in the above examples may have a gap in a surface thereof. The gap in each roller relieves pressure applied to the eyelid with which it is engaged when the gap is rotated over the eyelid (e.g., as the roller is rolled over the eyelid). This facilitates directional application of pressure from a first end of the glands toward an opening in the glands via which the fluid is expelled as the rollers are rotated.

In certain implementations, a spring is coupled with a roller (or rollers) as characterized herein. The spring may for example be integrated within an axle through the roller, or for example coupled to a frame or goggle to which the roller is coupled. The spring may facilitate movement of the roller relative to the wearable goggle and conforming of the roller to the patient's eyelids. The spring may also facilitate the application of a constant or near-constant pressure.

Another embodiment is directed to an apparatus including a frame, a plurality of rollers coupled to the frame, and an actuator to rotate the rollers. Each roller has an integrated heating element to heat the roller, and a gap region extending along a length of the roller. With the frame positioning each roller against a surface, the actuator operates with the frame and the rollers to apply pressure and heat to the surface via the rollers, while rotating the rollers. The gap region is utilized to relieve pressure applied by the roller when the gap is engaged with the surface (e.g., as the rotation places the gap in touch with the surface), therein massaging the surface in a direction of the rotation. Each roller may be coupled to a shaft, with each actuator also coupled to one of the shafts and to the frame for rotating the shafts and rollers coupled thereto. A strap may be utilized to secure the frame to a user's head and to facilitate the application of a spring force, from the frame unto the rollers, for applying pressure to a portion of the user's face to which the rollers are engaged.

In certain embodiments, the actuator may operate with the frame and rollers to heat eyelids by applying pressure and heat to the eyelids via the rollers, while the frame positions the roller against a surface over the eyelids and while rotating the rollers to massage the eyelids in a direction of the rotation. The rollers may facilitate the directional application of pressure from a first end of meibomian glands in the eyelids toward an opening in the glands via which heated fluid is expelled from the meibomian glands as the rollers are rotated.

In some implementations, four rollers are coupled to the frame and the frame is wearable by a patient. The frame operates with the four rollers and the actuator to align each of the four rollers respectively to four eyelids of the patient. With the rollers aligned, the rollers are rotated while applying heat and pressure to the eyelids to heat fluid in the patient's meibomian glands and to push the heated fluid out of the glands.

Another embodiment is directed to a method for heating eyelids using a frame and one or more rollers coupled to the frame, in which each roller has an integrated heating element to heat the roller. The frame is positioned with the one or more rollers against one of the eyelids, and pressure and heat are applied to the one of the eyelids via the at least one roller using an actuator to rotate the roller(s) to massage the one of the eyelids in a direction of the rotation. A spring may be used to facilitate conformance of each roller to the eyelids while applying the pressure thereto.

The rollers may be applied in a variety of manners. In some implementations, four rollers are coupled to the frame, the frame is coupled to a patient's head and each of the four rollers are respectively aligned to four eyelids of the patient. The rollers are rotated while applying heat and pressure to the eyelids to heat fluid in the patient's meibomian glands, and to push the heated fluid out of the glands.

Each roller may have a gap in a surface thereof that can be used to pressure applied to the eyelid with which it is engaged when the gap is pressed against the eyelid. This facilitates directional application of pressure from a first end of the glands toward an opening in the glands via which the fluid is expelled as the rollers are rotated. Each roller may also (or in the alternative) be attached to a shaft that may be rotated in a constant direction of rotation while utilizing a gap in the roller to apply directional pressure to move fluid within the one of the eyelids.

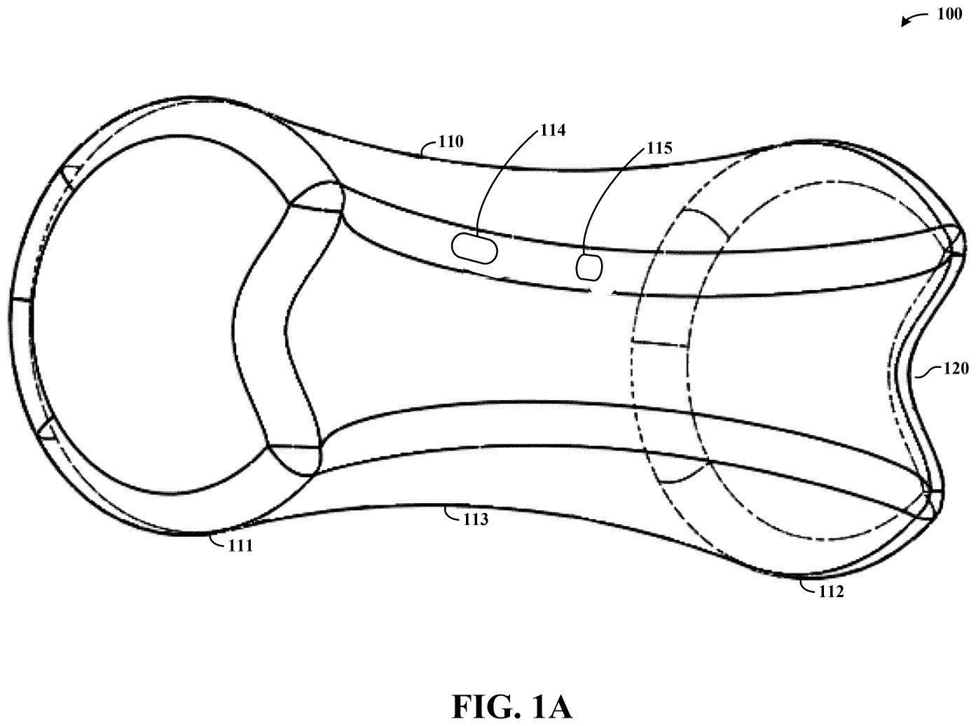

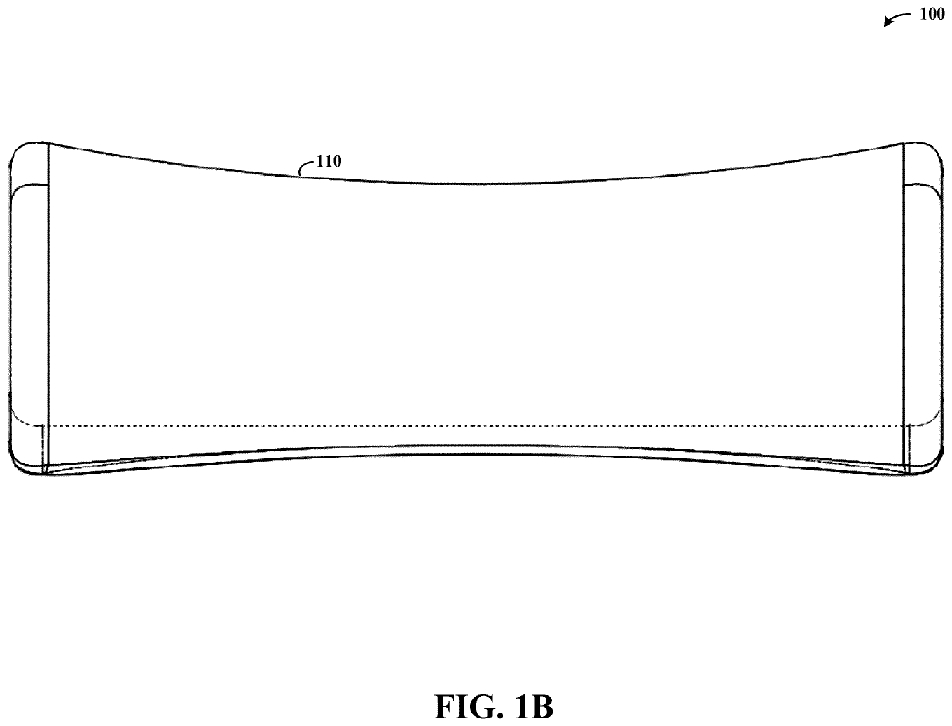

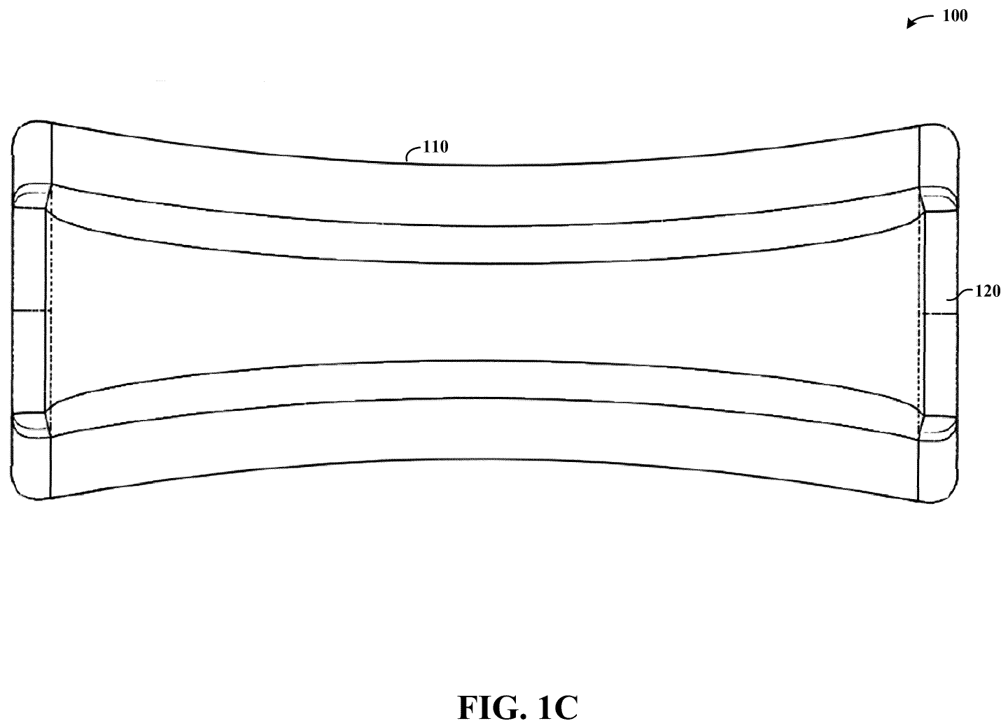

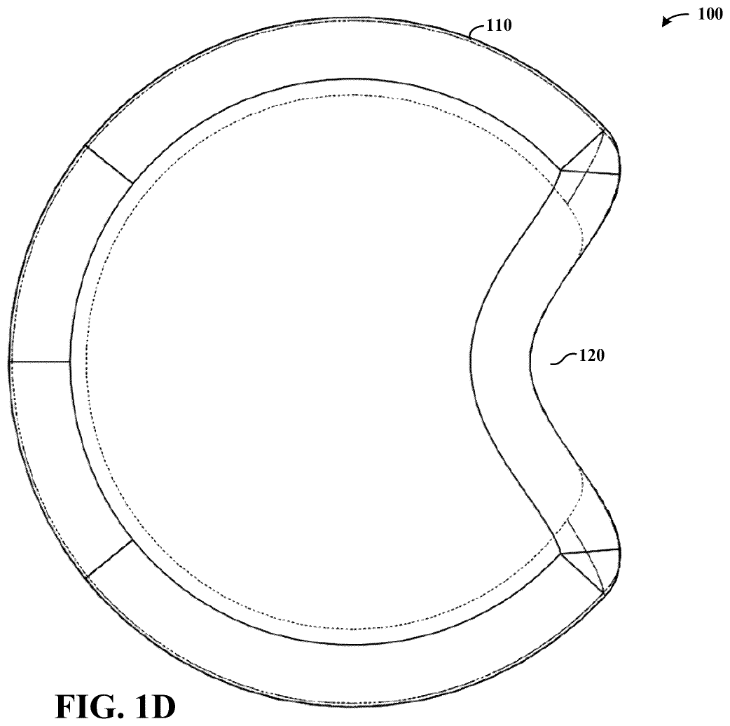

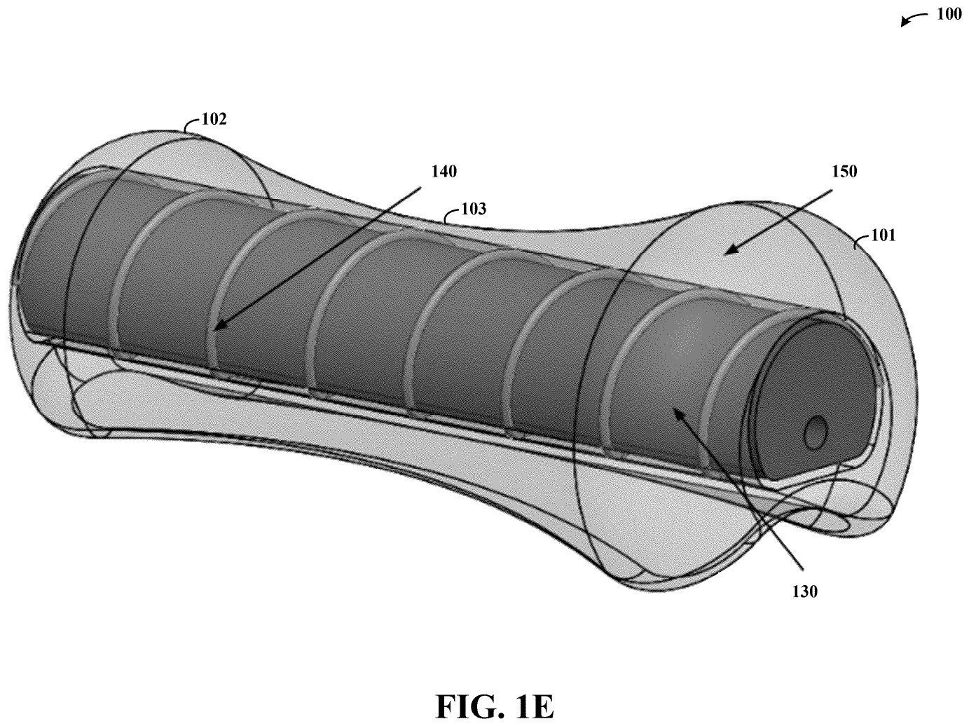

Turning to the figures, FIGS. 1A-1E show a roller apparatus 100 with incorporated heating, in accordance with one or more embodiments. FIG. 1A shows an isometric view, FIG. 1B shows a rear view, FIG. 1C shows a front view, and FIG. 1D shows an end view. FIG. 1E shows a cut-away view of an implementation utilizing a heating coil at a core portion of the roller apparatus, as may be implemented with a particular embodiment. Referring to FIG. 1A, the apparatus 100 has a tapered cylinder shape, with respective ends 111 and 112 of the roller having a larger diameter than a tapered central region 113. A gap region 120 relieves pressure on the eyelid as the apparatus is rotated through with the gap facing the eyelid.

The dimensions of the roller may be tailored specifically to the anatomy of the upper and lower meibomian glands, and each cylinder may be tapered to account for the natural shape of the eyelids. In a particular implementation, the roller apparatus 100 is 29 mm long, and tapers from an 8 mm diameter at the ends 111 and 112 to a 4 mm diameter at the center 113, and a 6 mm diameter at the inner corners.

Outer material 110 applies a compressive force to the skin and may be made of thermally conductive silicone, to facilitate heat transfer from the roller to the eyelid. The inner part of the cylinder may include an axle with a heating conductor. The roller apparatus 100 may be rotated while exerting a targeted force on the eyelid and with the device heated (e.g., to 43° C. for a five minute patient-use period). It has been recognized/discovered that the tapered “bean” shape of the roller allows for intermittent pressure to be applied to skin and meibomian glands during rotation, in a manner that accurately replicates linear massaging motion and allows for the user's skin to return to an unpressured state in between rotations.

In certain implementations, the apparatus 100 as shown in FIG. 1E may be wider at end 101 relative to the width at end 102 and a narrow center region 103, to tailor the application to certain eyelids. For instance, the width at end 101 may be 8 mm, the width at end 102 may be 6 mm, and the width at the center may be 4 mm. In other embodiments, the width at ends 101 and 102 may be the same, or of differing widths.

Referring to FIG. 1E, a more particular embodiment is shown utilizing the roller apparatus 100, with an axle 130 having a wire 140 wrapped around it for generating heat. The outer portion 150 of the roller may include thermally conductive silicone. In certain implementations, the roller is formed in a vacuum for degassing the silicon and mitigating the formation of inconsistencies therein. The axle 130 may be formed of an insulating polylactic acid (PLA) material, and the wire 140 may be formed of nichrome. The utilization of PLA for the axle 130 facilitates dissipation of energy generated by the wire 140 toward the outer portion of the thermally conductive silicone.

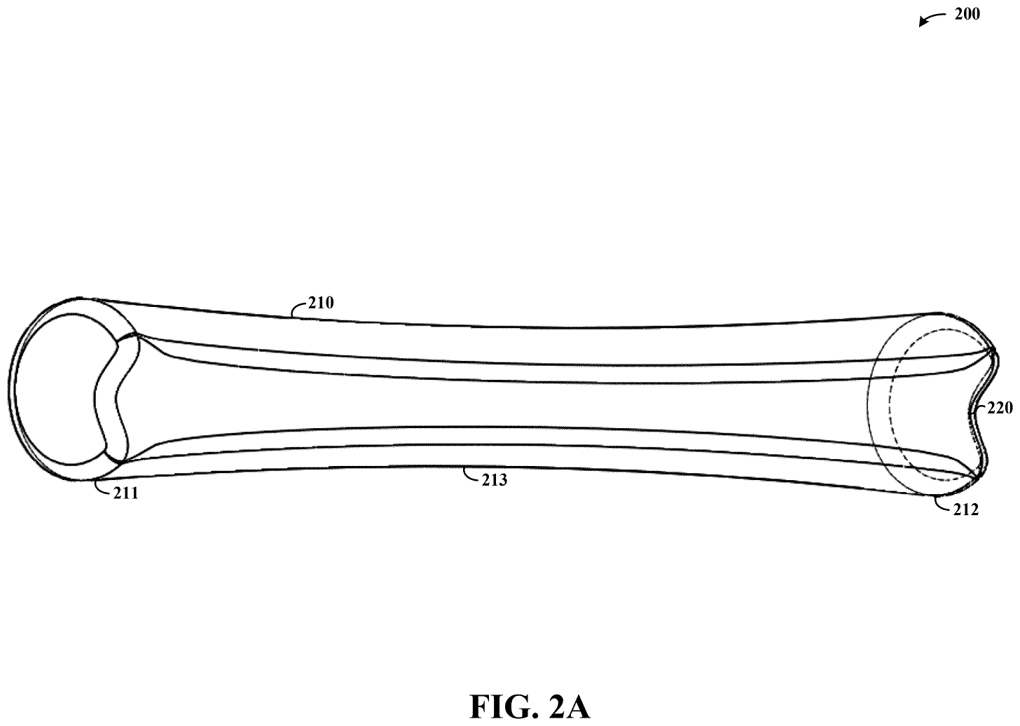

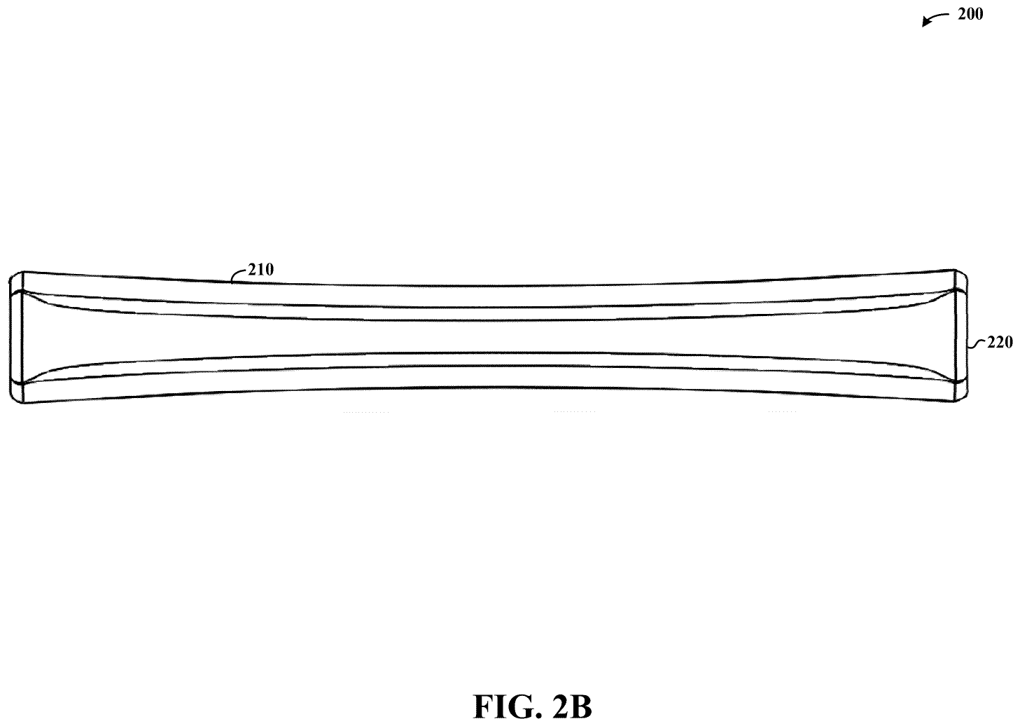

FIGS. 2A and 2B show an elongated roller apparatus 200 with incorporated heating, as may be implemented in accordance with various embodiments. FIG. 2A shows a perspective view of the apparatus 200, and FIG. 2B shows a front view. The apparatus 200 has an outer material 210 for engaging with the skin of an eyelid, and a gap region 220 for providing pressure relief when rotated in use, similar to the approach discussed with the apparatus 100 above. Ends 211 and 212 of the elongated roller apparatus 200 are wider than a central portion 213, providing an elongated bean shape.

The elongated roller apparatus 200 may be utilized in connection with the roller apparatus 100 shown in FIGS. 1A-1F, and may for example include heating components and related materials as shown in FIG. 1F. For instance, the elongated roller apparatus 200 can be utilized with a lower eyelid in conjunction with the roller apparatus 100 being utilized with an upper eyelid. In such implementations, both rollers may be similar in length (e.g., 29 mm), with the radius of the elongated roller apparatus 200 being less than that of the roller apparatus 100 to match the smaller width of the tarsus in the lower eyelid.

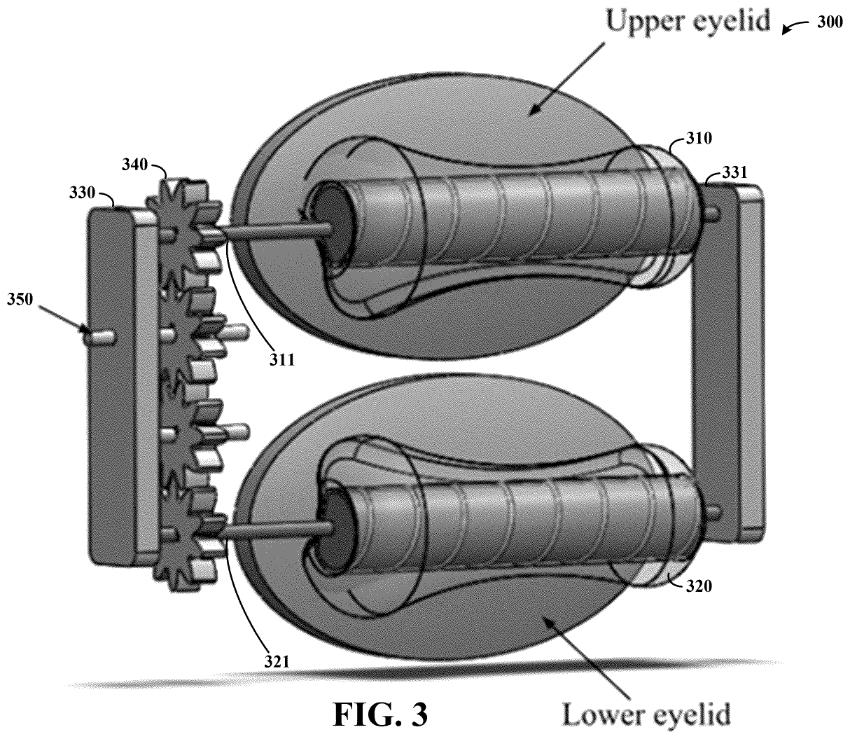

FIG. 3 shows an apparatus 300 for applying pressure and heat to upper and lower eyelids, as may be implemented in accordance with one or more embodiments. The apparatus includes an upper roller 310 for engaging with an upper eyelid, and a lower roller 320 for engaging with a lower eyelid. The rollers may be implemented in accordance with those rollers characterized in connection with FIGS. 1A-1F, and include features as shown.

The rollers have axles 311 and 321 that are coupled to frame ends 330 and 331 (e.g., with bearings), and to gear arrangement 340. A motor attachment 350 is configured to accept rotational power as an input and translate that through the gear arrangement 340 to the rollers 310 and 320.

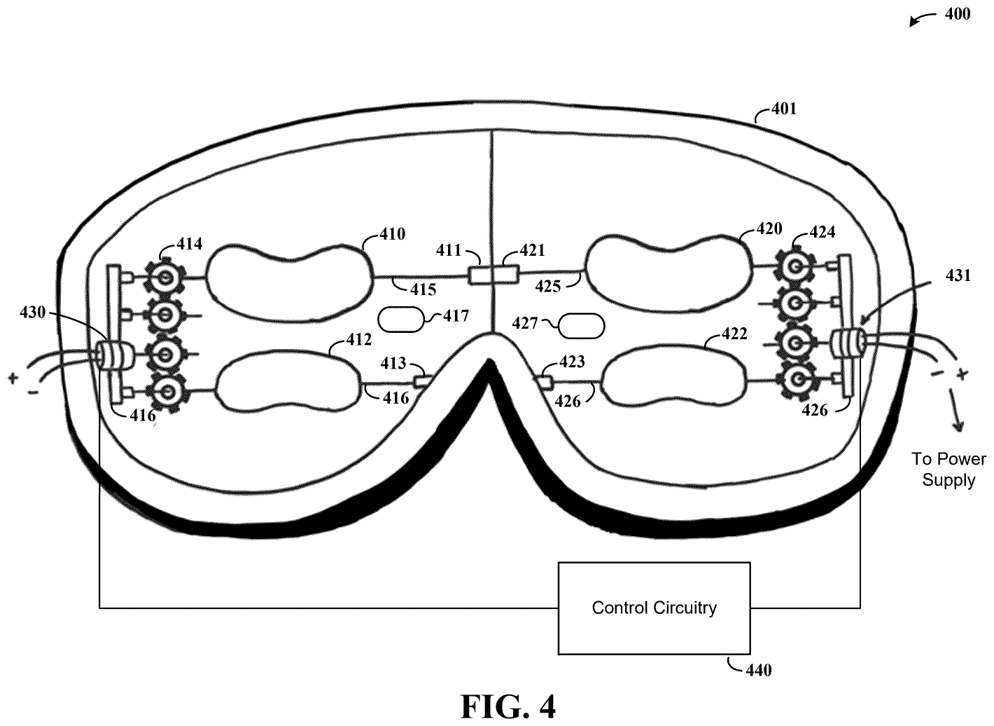

FIG. 4 shows a goggle apparatus 400 having rollers with incorporated heating, as may be implemented in accordance with one or more embodiments. The apparatus includes wearable goggles 401, to which upper eyelid rollers 410 and 420, and lower eyelid rollers 412 and 422, are connected. More specifically, rollers 410 and 412 are connected to a gear mechanism 414, which is in turn connected to a frame 416 that is coupled to the goggles 401. Shafts 415 and 416 respectively run through rollers 410 and 412, and are coupled to bearings in the frame 416 and to bearings 411 and 413, respectively. Similarly, rollers 420 and 422 are connected to gears 424 and frame 426, the latter of which is connected to the goggles 401. Shafts 425 and 426 run through the rollers 420 and 422, respectively, and are coupled to bearings in the frame 426 as well as to bearings 421 and 423 that are connected to the goggles 401.

DC motors 430 and 431 may be coupled to drive the gears 414. The DC motors operate using power from a power supply, which may be remotely connected via leads (e.g., to a hand-held power supply/controller) or may be locally mounted to the goggles. A battery may supply the power, for instance in a hand-held device or mounted to the goggles. A single power supply may supply both DC motors 430 and 431, or separate power supplies may be used for each DC motor.

The four rollers 410, 412, 420 and 422 may apply heat and pressure to the upper and lower eyelids of both eyes simultaneously. Power may be supplied to the rollers through the shafts 415, 416, 425 and 426, respectively. Nichrome wires may rest with the shafts for applying heat. The rollers may be rotated in opposite directions for the upper and lower eyelids, to apply compressive downward force on the upper eyelids and to apply compressive upward force on the lower eyelids. A constant rpm of 50 may be utilized to provide a normal force of 6 N across the geometry of the roller. The gears 414 and 424 facilitate translation of the DC motor input for rotation in opposite directions. For example, referring to DC motor 430, rotation of the upper roller 410 is in the same direction as that of the DC motor 430, as achieved via placement of a gear between the gear coupled to the DC motor and the gear coupled to the shaft 415 for the upper roller. Rotation of the lower roller 412 is in the opposite direction as the rotation of the DC motor 430, via the direct connection of the gear coupled to the DC motor, to the gear coupled to the shaft 416 for the lower roller.

A variety of types of circuitry may be implemented for controlling the apparatuses herein, including controlling rolling motion of the rollers as well as the application of heat. For instance, circuitry for powering four heating elements and two DC motors as shown in FIG. 4 may be implemented with a 3V battery. Each heating element may be modeled as a 3.9Ω resistor. A microcontroller may control the heating elements and DC motor operation. In certain implementations, an N-Channel Metal Oxide Semiconductor Field Effect Transistor (MOSFET) may be used to drive each set of two heating elements (two heating elements per eye) and the two DC motors. When the device is turned on, low voltage is supplied to the gate pins of the MOSFETs, which act as electronic switches, connecting the heating elements and motors to the 3 V power source. A 3 kΩ resistor may be placed in series with the DC motors to limit the rpm to 52. Where a nichrome wire is used, a wire temperature of 45° C. may be utilized to achieve a surface temperature on the rollers of about 43° C. Where a 3.9Ω segment of nichrome heating element wire is utilized a 1.7 V voltage supply may be utilized to heat a heating element in one of the rollers to 45° C., at a current draw of about 396 mA.

The apparatus 400 may be adjustable to fit diverse range of patients having various eye shapes, head size, eye location and more. For instance, the rollers 410, 412 420 and 422 may be positioned further apart laterally or vertically to suit such applications and ensure that the correct distance between the rollers and the surface of the eyelids is maintained. In order to accommodate these requirements, the device may telescope in both the medial-lateral direction to account for the bridge of the nose and the anterior-posterior direction to account for variation in orbital depth.

In certain embodiments, one or more heat sensors are utilized to sense heat being applied to the eyelids for controlling the heat application. For instance, a heat sensor may be used to ensure that the heating mechanism does not overheat and cause harm to the user. Such heat sensors may be integrated within the rollers, or located separate from the rollers located for assessing heat. For instance, referring to FIG. 1A, a heat sensor 114 may be integrated within material near the surface 110 of the roller. Such a heat sensor may include a thermocouple and related componentry for sensing conductive heat. Referring to FIG. 4, sensors 417 and 427 may be coupled to the goggles 401 and respectively utilized to sense heat applied by rollers 410/412, and 420/422. The sensors 417 and 427 may include infrared heat sensors that optically detect infrared radiation.

Pressure sensors may be utilized in connection with one or more embodiments. For instance, pressure sensors may assess pressure applied to a user's eyelid to facilitate the control and placement of rollers as characterized herein. An automatic shutoff may be utilized to shut the rollers off under conditions in which pressure exceeds a threshold, to ensure safety for the user and prevent bodily harm. Further, pressure feedback may be provided for use in adjusting the position of the rollers relative to a user's eyelids. Based on such feedback, the rollers may be manually or automatically positioned utilizing mechanical movement (e.g., an actuator that may move the rollers in one or more directions relative to the user's face).

Such pressure sensors may be implemented in a variety of manners. Referring again to FIG. 1A, a pressure sensor 115 may be integrated within the roller 100 in an outer region thereof. The pressure sensor 115 may utilize one or more of a variety of types of sensors that may sense physical pressure, such as capacitive or piezoelectric sensors. An output from the pressure sensor 115 may be sent to controller circuitry for utilization, for example in providing an output indicative of the sensed pressure and/or to provide feedback that automatically controls the application of pressure (e.g., as a shut-off for high pressure or as a control to increase or decrease applied pressure).

Control circuitry 440 may be implemented to operate the apparatus 400. For example, such control circuitry could be integrated with a hand-held power supply, to supply power and control the operation of one or both of heat and roller rotation. When implemented with heat sensors 417 and 427, the controller may control the application of heat based on outputs from the sensors. When implemented with pressure sensors such as those characterized above with FIG. 1A (e.g., where the roller in FIG. 1A is utilized in the apparatus 400), the control circuitry 440 may also operate to monitor pressure applied to the eyelids. Further, with pressure monitoring, the control circuitry 440 may operate to turn off or otherwise modify the operation of the apparatus 400 in the event that a high-pressure condition is detected.

Various aspects as characterized herein are useful for implementing the claimed disclosure by way of circuits or circuitry that may be illustrated as or using terms such as blocks, modules, device, system, unit, controller, and/or other circuit-type depictions (see, e.g., FIGS. 1A and 4). Such circuits or circuitry may be used together with other elements to exemplify how certain embodiments may be carried out in the form or structures, steps, functions, operations, activities, etc. For example, in certain of the above-discussed embodiments, one or more control circuits or other modules are discrete logic circuits or programmable logic circuits configured and arranged for implementing these operations/activities, as may be carried out in the approaches disclosed.

Certain specific examples, relating to the above-described aspects, are directed to a computer program product (e.g., non-volatile memory device), which includes a machine or computer-readable medium having stored thereon instructions which may be executed by a computer (or other electronic device) to perform these operations/activities. In certain such CPU-related embodiments, a programmable circuit may be used as one or more computer circuits, including memory circuitry for storing and accessing a program to be executed as a set (or sets) of instructions (and/or to be used as configuration data to define how the programmable circuit is to perform), and an algorithm or process as described above is used by the programmable circuit to perform the related steps, functions, operations, activities, etc. Depending on the application, the instructions (and/or configuration data) can be configured for implementation in logic circuitry, with the instructions (whether characterized in the form of object code, firmware or software) stored in and accessible from a memory (circuit).

The above-characterized figures and discussion are provided to help illustrate certain aspects (and advantages in some instances) that may be used in the manufacture of such structures and devices. These structures and devices include the exemplary structures and devices described in connection with each of the figures and may include other devices, as each such described embodiment has one or more related aspects which may be modified and/or combined with the other and examples as described hereinabove.

Various terminology as used in the present disclosure may be defined by way of their plain meaning. Further, terms to exemplify orientation, such as upper/lower, left/right, top/bottom, up/down above/below, medial/lateral and anterior/posterior may be used herein to refer to relative positions of components as shown in the figures. It should be understood that the terminology is used for notational convenience only and that in actual use the disclosed structures may be oriented different from the orientation shown in the figures. Thus, the terms should not be construed in a limiting manner.

Based upon the above discussion and illustrations, those skilled in the art will readily recognize that various modifications and changes may be made to the various embodiments without strictly following the exemplary embodiments and applications illustrated and described herein. For example, fewer or more rollers may be used, including utilizing more than one roller per eyelid, the size and shape of the rollers may be adjusted, the type of roller material may be varied, and the applied heat can be provided in a number of manners. Various control approaches may be utilized, and various sensors such as those characterized herein can be utilized for controlling the application of heat and/or pressure to a user's eyelids. Such modifications do not depart from the true spirit and scope of various aspects of the invention, including aspects set forth in the claims.

What is claimed is:

1. An apparatus for heating eyelids, the apparatus comprising:
a frame;
at least one roller coupled to the frame, each roller having an integrated heating element to heat the roller; and
an actuator to rotate the at least one roller, the actuator being configured with the frame and the at least one roller to, with the frame positioning the roller against a surface over one of the eyelids, apply pressure and heat to the surface and to the one of the eyelids via the at least one roller, while rotating the at least one roller to massage the surface and the one of the eyelids in a direction of the rotation.

2. The apparatus of claim 1, wherein:
the at least one roller includes four rollers coupled to the frame; and
the frame is wearable by a patient and configured with the four rollers and the actuator to:
align each of the four rollers respectively to four eyelids of the patient,
rotate the rollers while applying heat and pressure to the eyelids to heat fluid in meibomian glands of the patient and to push the heated fluid out of the meibomian glands.

3. The apparatus of claim 2, including a wearable goggle configured to be worn on the patient's head and having a strap, wherein the frame is part of the wearable goggle and the strap is configured with the frame to position the rollers against the patient's eyelids.

4. The apparatus of claim 2, wherein each of the rollers has gap in a surface thereof.

5. The apparatus of claim 4, wherein each roller is configured to relieve pressure applied to the eyelid with which it is engaged when the gap is pressed against the eyelid, therein facilitating directional application of pressure from a first end of the glands toward an opening in the glands via which the fluid is expelled as the rollers are rotated.

6. The apparatus of claim 2, including a wearable goggle configured to be worn on the patient's head and having a strap, wherein the frame is part of the wearable goggle and the strap is configured with the frame to position the rollers against the patient's eyelids.

7. The apparatus of claim 6, further including a spring for each roller, coupled to the wearable goggle and to the roller to facilitate movement of the roller relative to the wearable goggle and conforming of the roller to the patient's eyelids.

8. The apparatus of claim 2, wherein:
each roller is attached to a shaft; and
each actuator is coupled to one of the shafts and to the frame, and configured to rotate the one of the shafts to rotate the roller coupled thereto.

9. The apparatus of claim 1, wherein the at least one roller has a gap in a surface thereof to provide pressure relief to a portion of the eyelid with which it is engaged as the gap is rolled against the eyelid, therein facilitating directional application of pressure to the eyelids.

10. An apparatus comprising:
a frame;
a plurality of rollers coupled to the frame, each roller having an integrated heating element to heat the roller, and having a gap region extending along a length of the roller; and
an actuator configured with the frame and the rollers to, with the frame positioning each roller against a surface, apply pressure and heat to the surface via the rollers while rotating the rollers, including utilizing the gap region to relieve pressure applied by the roller when the gap is engaged with the surface, therein massaging the surface in a direction of the rotation.

11. The apparatus of claim 10, wherein the actuator is configured with the frame and rollers to apply the pressure and heat to the eyelids by, with the frame positioning each roller against a surface over one of the eyelids, applying pressure and heat to the surface and to the one of the eyelids via the roller while rotating the roller to massage the surface and the eyelid in a direction of the rotation.

12. The apparatus of claim 11, wherein the rollers facilitate the directional application of pressure from a first end of meibomian glands in the eyelids toward an opening in the glands via which heated fluid is expelled from the meibomian glands as the rollers are rotated.

13. The apparatus of claim 10, wherein:
the plurality of rollers includes four rollers coupled to the frame; and
the frame is wearable by a patient and configured with the four rollers and the actuator to:
align each of the four rollers respectively to four eyelids of the patient,
rotate the rollers while applying heat and pressure to the eyelids to heat fluid in meibomian glands of the patient and to push the heated fluid out of the meibomian glands.

14. The apparatus of claim 10, further including a strap configured to secure the frame to a user's head and to facilitate the application of a spring force, from the frame unto the rollers, for applying pressure to a portion of the user's face to which the rollers are engaged.

15. The apparatus of claim 10, wherein:
each roller is attached to a shaft; and
each actuator is coupled to one of the shafts and to the frame, and configured to rotate the one of the shafts to rotate the roller coupled thereto.

16. A method for heating eyelids, the method comprising:
providing a frame and at least one roller coupled to the frame, each roller having an integrated heating element to heat the roller; and
using an actuator, with the frame positioning the at least one roller against one of the eyelids, apply pressure and heat to the one of the eyelids via the at least one roller, by rotating the at least one roller to massage the one of the eyelids in a direction of the rotation.

17. The method of claim 16, wherein the at least one roller includes four rollers coupled to the frame, further including:
coupling the frame to a patient's head;
aligning each of the four rollers respectively to four eyelids of the patient; and
rotating the rollers while applying heat and pressure to the eyelids to heat fluid in meibomian glands of the patient and to push the heated fluid out of the meibomian glands.

18. The method of claim 16, wherein each roller has gap in a surface thereof, wherein applying the pressure includes utilizing the gap to relieve pressure applied to the eyelid with which it is engaged when the gap is pressed against the eyelid, therein facilitating directional application of pressure from a first end of the meibomian glands toward an opening in the glands via which the heated fluid is expelled as the rollers are rotated.

19. The method of claim 16, including utilizing a spring to facilitate conformance of each roller to the eyelids while applying the pressure thereto.

20. The method of claim 16, wherein each roller is attached to a shaft, and wherein using the actuator and rotating the at least one roller includes rotating the shaft for each roller in a constant direction of rotation while utilizing a gap in the at least one roller to apply directional pressure to move fluid within the one of the eyelids.
